(19) United States
(12) Patent Application Publication
(10) Pub. No.: US 2014/0303952 A1
(43) Pub. Date: Oct. 9, 2014

(54) PROTEIN-LIGAND DOCKING

(71) Applicants: Doris Zhiguan WANG, Kowloon (HK); Hong YAN, Kowloon (HK)

(72) Inventors: Doris Zhiguan WANG, Kowloon (HK); Hong YAN, Kowloon (HK)

(73) Assignee: CITY UNIVERSITY OF HONG KONG, Kowloon (HK)

(21) Appl. No.: 13/923,930

(22) Filed: Jun. 21, 2013

Related U.S. Application Data
(60) Provisional application No. 61/809,783, filed on Apr. 8, 2013.

(51) Int. Cl. G06F 19/12

(52) U.S. Cl. CPC G06F 19/12
USPC 703/11

(57) ABSTRACT

Prediction of a preferred position and orientation of a ligand bound to a macromolecule is described. The ligand and the macromolecule can form a stable complex based on matching of physico-chemical properties and probabilistic relaxation labeling. The macromolecule can be a protein and a physico-chemical property can be hydrogen bonding. A potential docking location for the ligand on the surface of the protein is determined. Then, on the potential docking location and the ligand, the donor and acceptor atoms are identified. Probabilistic relaxation labeling is utilized to facilitate identification of the potential matching pairs of donors and acceptors, according to local shape complementarity and a geometric constraint for the conformation of hydrogen bond. A scoring function can rank the potential matching pairs to obtain the preferred ligand position.

### CROSS REFERENCE TO RELATED APPLICATION

This application claims priority to U.S. provisional application No. 61/809,783, filed on Apr. 8, 2013 and entitled: “PROTEIN-LIGAND DOCKING BASED ON HYDROGEN BOND MATCHING AND PROBABILISTIC RELAXATION LABELING.” The entirety of this provisional application is incorporated herein by reference.

### TECHNICAL FIELD

This disclosure generally relates to prediction of the preferred position and orientation of a ligand bound to a macromolecule to form a stable complex based on matching of a physico-chemical property and probabilistic relaxation labeling.

### BACKGROUND

Protein-ligand docking is a molecular modeling method that can predict the position and orientation of a ligand when it is bound to a macromolecule to form a stable complex. The pharmaceutical industry employs protein-ligand docking techniques for a variety of purposes. In the field of drug discovery, with the support of biophysical techniques, such as X-ray crystallography and NMR spectroscopy, protein-ligand docking has become a widely used tool for virtual screening of large databases of chemicals to select likely drug candidates. Protein-ligand docking can help to predict the affinity and activity of the various chemicals when bound to certain macromolecules. Beyond drug discovery, protein-ligand docking methods also have been utilized to predict protein function and potential protein targets of a particular molecule.

Protein-ligand docking requires extensive computational resources. With the increase of computer power over the last decade, protein-ligand docking techniques are commonly used for drug discovery and are now being developed for modeling both protein and ligand flexibilities. Modeling the flexibilities of proteins and ligands has been difficult due to the large number of degrees of freedom that need to be considered in these calculations. Neglecting the degrees of freedom leads to poor docking results in real world settings.

Available algorithms to account for protein flexibilities are mainly developed based on the following approaches: soft receptors, side chain flexibility, molecular relaxation and protein ensemble. These algorithms, however, often require long computing time and multiple runs to achieve higher accuracy. Accordingly, accurately and efficiently predicting protein-ligand interactions for large datasets remains one of the most important and difficult problems in the study of biomolecular interactions.

The above-described background is merely intended to provide an overview of contextual information regarding protein-ligand docking, and is not intended to be exhaustive. Additional context may become apparent upon review of one or more of the various non-limiting embodiments of the following detailed description.

### SUMMARY

The following presents a simplified summary of the specification in order to provide a basic understanding of some aspects of the specification. This summary is not an extensive overview of the specification. It is intended to neither identify key or critical elements of the specification nor delineate any scope of particular embodiments of the specification, or any scope of the claims. Its sole purpose is to present some concepts of the specification in a simplified form as a prelude to the more detailed description that is presented later. In accordance with one or more embodiments and corresponding disclosure, various non-limiting aspects are described in connection with prediction of a preferred position and orientation of a ligand bound to a macromolecule to form a stable complex based on matching of a physico-chemical property and probabilistic relaxation labeling. Generally, the probabilistic relaxation labeling associates a set of labels to a set of objects and can be used to predict if two molecules can interact with each other.

In an embodiment, the physico-chemical property is a hydrogen bond, and the prediction is accomplished via a docking algorithm that is based on the hydrogen bond local shape complementarity and a relaxation labeling scheme for matching. The embodiments described herein can accurately and efficiently predicting macromolecule-ligand, including protein-ligand, interactions, even when for large datasets must be examined to determine the stable bindings.

In a non-limiting embodiment, a system is described that facilitates prediction of a preferred position and orientation of a ligand bound to a macromolecule (e.g., a protein, enzyme, or the like). The system includes a memory to store computer-executable instructions and a processor that executes or facilitates execution of the computer-executable instructions. Upon execution of the instructions, the system can obtain a potential binding site for a ligand on a surface of a macromolecule (e.g., packet of a protein); identify donor atoms and acceptor atoms on the potential binding site and the ligand; solve an optimization problem through probabilistic relaxation labeling to facilitate identification of a set of potential matching pairs of the donors and the acceptors on the potential binding site and the ligand based on a geometric constraint for conformation of a physico-chemical interaction between the ligand and the potential binding site; and rank potential matching pairs of the set of the potential matching pairs according to a defined scoring function to obtain a ligand position that satisfies a defined energy condition with respect to the potential binding site. The embodiments described herein can be applied to rigid ligands and flexible ligands. The macromolecule can be assumed to be rigid in some embodiments. In other embodiments, the macromolecule can be treated as flexible.

According to another non-limiting embodiment, a method is described that facilitates prediction of a preferred position and orientation of a ligand bound to a macromolecule (e.g., a protein, enzyme, or the like). The acts of the method can be performed, for example, by a system comprising a processor. The acts include: estimating respective initial probabilities for each of the potential donor-acceptor pairs and computing the compatible coefficient matrix; creating matched pairs of donors and acceptors between a ligand and a macromolecule surface via probability relaxation labeling; determining ligand positions based on a rotation parameter and a translation parameter; and ranking the ligand positions according to a defined scoring function.

In a further non-limiting embodiment, a computer-readable storage device is described that facilitates prediction of a preferred position and orientation of a ligand bound to a macromolecule (e.g., a protein, enzyme, or the like). The computer-readable storage device stores computer-executable instructions that, in response to execution, cause a system comprising a processor to perform operations. The operations include: identifying a potential binding site for a ligand on a surface of a macromolecule; matching the potential donor-acceptor pairs between macromolecule and ligand through relaxation labeling; displacing the ligand based on quaternion based best-fit RMSD algorithm and determining a docked complex between the macromolecule and the ligand based on the displacing of the ligand that satisfies a defined criterion.

The following description and the drawings set forth certain illustrative aspects of the specification. These aspects are indicative, however, of but a few of the various ways in which the various embodiments of the specification may be employed. Other aspects of the specification will become apparent from the following detailed description of the specification when considered in conjunction with the drawings.

### BRIEF DESCRIPTION OF THE DRAWINGS

Numerous aspects and embodiments are set forth in the following detailed description, taken in conjunction with the accompanying drawings, in which like reference characters refer to like parts throughout, and in which:

FIG. 1 is an example non-limiting schematic diagram of a system that can identify a preferred binding between a macromolecule and a ligand, according to an aspect or embodiment of the subject disclosure;

FIG. 2 is a non-limiting example of ideal acceptors A′ added in five possible positions to hydroxyl groups of serine, threonine and tyrosine residues, according to an aspect or embodiment of the subject disclosure;

FIG. 3 is a non-limiting illustration of an example situation where two hydrogen bonds can coexist, according to an aspect or embodiment of the subject disclosure;

FIG. 4 is an example non-limiting schematic diagram of a system that find potential bindings between a macromolecule and a ligand according to a physico-chemical property and relaxation labeling, according to an aspect or embodiment of the subject disclosure;

FIGS. 5 and 6 are example non-limiting illustrations of construction of a local patch histogram, according to an aspect or embodiment of the subject disclosure;

FIG. 7 is a non-limiting illustration of an example situation where one hydrogen bonds exists and the ligand is capable of rotating freely, according to an aspect or embodiment of the subject disclosure;

FIG. 8 is a non-limiting illustration of an example situation where two potential hydrogen bonds exist and can rotate freely around the axis that passes through the two potential hydrogen bonding sites, according to an aspect or embodiment of the subject disclosure;

FIG. 9 is an example non-limiting process flow diagram of a method that facilitate fast discovery of potential macromolecule-ligand docking positions, according to an aspect or embodiment of the subject disclosure;

FIG. 10 illustrates an example non-limiting computing environment in which any one of the various aspects or embodiments described herein can be implemented;

FIG. 11 illustrates an example of a computer network in which any one of the various aspects or embodiments described herein can be implemented;

FIG. 12 is an example non-limiting list of elements in the rigid dataset, including the PBD names, the number of intermolecular hydrogen bonds, and the RMSD (Angstroms), according to an aspect or embodiment of the subject disclosure;

FIG. 13 is an example non-limiting list of elements in the flexible dataset, including the PBD names, the number of intermolecular hydrogen bonds, and the RMSD (Angstroms), according to an aspect or embodiment of the subject disclosure;

FIG. 14 is an example non-limiting chart showing the success rate and the average RMSD of testing cases with different intermolecular hydrogen bonds for the rigid data set, according to an aspect or embodiment of the subject disclosure;

FIG. 15 is an example non-limiting chart showing the success rate and the average RMSD of testing cases with different intermolecular hydrogen bonds for the flexible data set, according to an aspect or embodiment of the subject disclosure;

FIG. 16 is an example non-limiting chart illustrating the average computation time for various steps of the fast protein-ligand docking algorithm, according to an aspect or embodiment of the subject disclosure;

FIG. 17 is an example non-limiting chart illustrating the performance of the fast protein-ligand docking algorithm compared to other published docking algorithms, according to an aspect or embodiment of the subject disclosure; and

FIG. 18 is an example non-limiting chart comparing the successful docking rate achieved by the fast protein-ligand docking algorithm and the H-DOCK algorithm, according to an aspect or embodiment of the subject disclosure.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that the certain aspects of disclosure may be practiced without these specific details, or with other methods, components, molecules, etc. In other instances, well-known structures and devices are shown in block diagram form to facilitate description and illustration of the various embodiments.

The subject application is generally related to systems, devices and methods that can facilitate execution of a fast macromolecule-ligand docking algorithm that can facilitate the prediction of a preferred position and orientation of a ligand bound to a macromolecule. As used herein, the term, “macromolecule” generally refers to a very large molecule that is created by polymerization of smaller subunits or monomers. The term macromolecule includes proteins (e.g., receptors, enzymes, and the like) nucleic acids, carbohydrates, lipids, macrocycles, and the like. The term, “ligand,” as used herein, generally refers to a substance, usually a small molecule, that forms a complex with the macromolecule. A ligand can form a complex with a macromolecule (or dock with the macromolecule) to serve a biological purpose—for example, a ligand can bind to a site on a protein receptor to trigger a signal. The binding between the ligand and the macromolecule can occur by intermolecular forces, such as ionic bonds, hydrogen bonds, van der Waals forces. Generally, the binding or docking is reversible.

The ligand and the macromolecule can form a stable complex based on matching of a physico-chemical property (e.g., as ionic bonds, hydrogen bonds or van der Waals forces) and probabilistic relaxation labeling. In the embodiments and aspects described herein, the macromolecule is a protein and the physico-chemical property is hydrogen bonding. It will be understood, however, that proteins and hydrogen bonding are merely chosen for simplicity of illustration and explanation. Other physico-chemical properties and other macromolecule types are within the scope of this application.

A fast macromolecule-ligand docking algorithm and systems, devices, and methods that facilitate performance of the algorithm are described herein. The fast macromolecule-ligand docking algorithm is generally a molecular modeling technique that can predict the position and orientation of a ligand when it is bound to a macromolecule to form a stable complex. The functionality of the fast macromolecule-ligand docking algorithm is similar to the functionality of other protein-ligand docking algorithms.

Generally, there are two main components to any protein-ligand docking algorithm: (1) a searching algorithm to generate ligand conformations and their orientation with respect to the protein and (2) a scoring function to predict how strongly the docked ligand binds to the protein. Requirements of a good searching algorithm include: the algorithm should be fast and effective and allow for the degrees of freedom of the protein-ligand complex to be sampled sufficiently so as to include the true binding modes. Commonly used types of searching algorithms include: the shape complementarity method, geometry based methods, and a combination of geometric and hydrogen bond complementarity.

The shape complementarity method is one of the most commonly used techniques in many docking programs. Compared to molecular dynamic simulation based approaches, shape complementarity methods are very efficient since they can scan through a large number of ligands quickly. Shape complementarity methods are generally based on the idea of shape matching between the protein and the ligand. Most shape complementarity methods describe the protein and the ligand as a set of features based on geometric and physico-chemical properties.

Geometry-based methods perform the matching between molecular surfaces in terms of geometric descriptors, including pockets, holes, surface normal, and so forth. Many attempts have been made to use geometric descriptors to model proteins and ligands. However, these methods are often sensitive to small geometric feature changes and may result in false positive predictions. Some more recent methods have been developed to reduce the sensitivity and to improve the efficiency of geometric docking.

To achieve more accurate solutions, many methods combine geometric complementarity with physico-chemical information, including electrostatics, hydrophobicity, hydrogen bonds, solvation energy, and so forth. Complementarity of these properties has been previously demonstrated to exist between the contact docking surfaces of a complex.

The combination of geometric and hydrogen bond complementarity is often used as an initial step to obtain possible docking sites. Hydrogen bonding has been demonstrated to be important for the structure and function of biomolecules. In a stable complex, the interacting donor and acceptor sites of the intermolecular hydrogen bonds are required to have a certain degree of spatial and directional complementarity, which can be used for the docking of two molecules. A maximum clique algorithm can be introduced to find maximally complementary sets of hydrogen bond donor/acceptor pairs. These methods are feasible to achieve protein-ligand docking, but they only consider the geometric complementarity of hydrogen bonds and the exhaustive search of the maximum clique increases the computational cost, as well as the memory requirement. In addition, the true hydrogen bonds can be missed, since they only find the maximal cliques of the docking graph. A more recent approach, H-DOCK, introduces a divide-and-conquer strategy based enumeration method. The H-DOCK approach is a combinatorial indexing method and needs to generate all possible hydrogen bonding modes.

After generating a list of binding poses in the searching process, a scoring function is needed to recognize the native pose from other decoys created during the search. The scoring function should be able to produce a correct ranking for the true binding pose and fast enough for the sake of efficiency. The scoring functions often rely on relatively simple descriptors of intermolecular interactions between protein and ligand, such as hydrogen bonding and hydrophobic interactions and these energy functions need to be fairly “soft” so that the ligands are not heavily penalized for small errors in the binding geometry. Generally, the scoring functions can be classified into three types: (1) force field scoring function (e.g., D-score, G-score, GoldScore, AutoDock), which is based on decomposition of the ligand binding energy into individual interaction terms with a set of derived force-field parameters; (2) empirical scoring functions (e.g., F-score, ChemScore, X-score) in which the binding energy score of the complex is deduced by summation of a series of weighted empirical energy terms; and (3) knowledge-based scoring function (e.g., DrugScore, SmoG) with potential parameters directly derived from structural information in experimentally determined protein-ligand complexes. For any scoring function, speed and accuracy are two important characteristics that are needed to be considered. Speed is no longer a great concern since computing power has increased in recent years. However, accuracy is still a main concern with regard to development of a scoring function for protein docking.

The fast macromolecule-ligand docking algorithm increases accuracy and also allows the algorithm to execute efficiently at a fast speed. Generally, in the fast macromolecule-ligand docking algorithm, a potential docking location for the ligand on the surface of the protein is determined (e.g., a pocket). Then on both the potential docking location and the ligand, the donor and acceptor atoms are identified. Relaxation labeling is utilized to identify the potential matching pairs on both the protein and ligand, according to a geometric constraint for the conformation of hydrogen bond. A scoring function can rank the potential matching pairs to obtain the preferred ligand position.

Generally, relaxation labeling is an approach using parallel numerical procedures and contextual constraints to minimize an energy with a discreet label set. The basic elements of a relaxation labeling method are a set of features belonging to an object and a set of labels. The labeling schemes are probabilistic in that for each feature, weights or probabilities are assigned to each label in the set giving an estimate of the likelihood that the particular label is the correct one for that feature. Probabilistic approaches are then used to maximize or minimize the probabilities by iterative adjustment, taking into account the probabilities associated with neighboring features. The scoring function is used to rank the potential matching pairs with minimized energy discovered from the relaxation labeling method to obtain the preferred ligand position.

The fast macromolecule-ligand docking algorithm improves over previous protein-ligand docking algorithms at least because the fast macromolecule-ligand docking algorithm examines multiple physico-chemical properties (e.g., multiple hydrogen bonds) and introduces a robust probabilistic labeling framework to match many acceptors and donors simultaneously. The local shape complementarity of hydrogen bond is used to estimate the initial probability, and the geometric coexisting condition of two hydrogen bonds is taken into account for the compatibility coefficient matrix. The hydrogen bonding geometric complementarity in the updating process reduces noise in the hydrogen bond matching procedure.

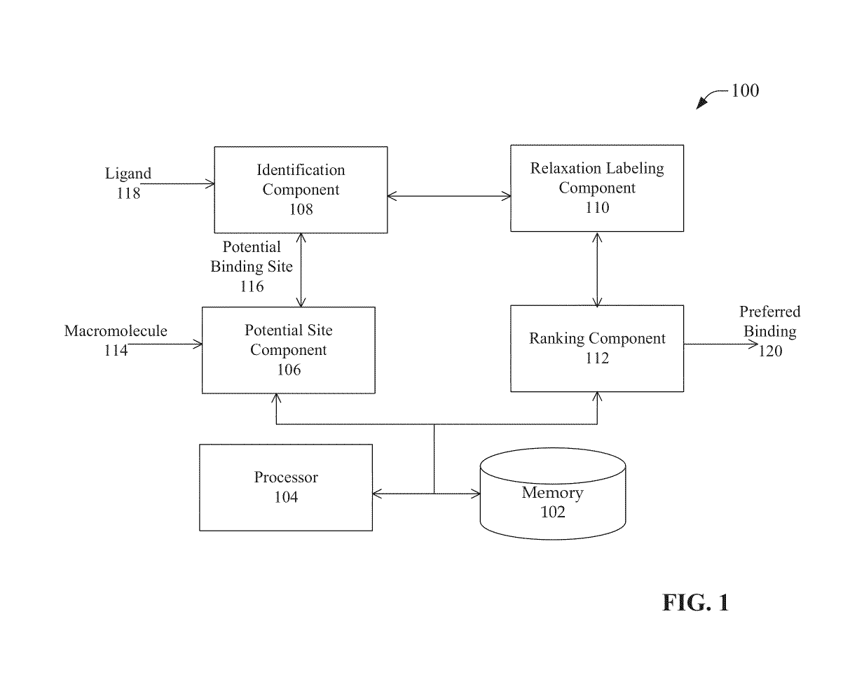

Referring now to FIG. 1, illustrated is an example non-limiting schematic diagram of a system 100 that can identify a preferred binding 120 between a macromolecule 114 and a ligand 118, according to an aspect or embodiment of the subject disclosure. System 100 can facilitate execution of the fast macromolecule-ligand docking algorithm. The fast macromolecule-ligand docking algorithm is also interchangbly referred to as LSRL-Dock in the figures and description. System 100 can facilitate the execution of the fast macromolecule-ligand docking algorithm in situations where the ligand 114 is assumed to be rigid and also in situations that incorporate ligand flexibility. The flexible ligand can be examined as a number of conformations of the ligand where each conformation is represented as a rigid model. Although only situations where the macromolecule is rigid are discussed, it will be understood that system 100 can also be utilized when the macromolecule is considered to be flexible.

System 100 includes a memory 102 that can store instructions, components, or the like. System 100 also includes a processor 104 that can execute or facilitate execution of the instructions, components, or the like to facilitate the performance of various operations associated with the instructions, components, or the like. The memory 102 and the processor 104 are both hardware devices that can be utilized within a computing device. Memory 102 and processor 104 can be part of a single device or distributed through different devices.

The memory 102 can store various components, whose execution can be facilitated by the processor 104. The components include at least a potential site component 106, an identification component 108, a relaxation labeling component 110, and a ranking component 112. The potential site component 106 can obtain a potential binding site 116 for a ligand 118 on a surface of a macromolecule 114. The identification component 108 can identify donor atoms and acceptor atoms on both the potential binding site 114 and the ligand 116. The relaxation labeling component 110 can utilize a relaxation labeling technique to identify a set of potential matching pairs of donors and acceptors on both the potential binding site 114 and the ligand 116 based on a geometric constraint for conformation of a physico-chemical interaction between the ligand 116 and the potential binding site 114. The ranking component 112 can rank potential matching pairs from the set of the potential matching pairs according to a scoring function to obtain a lowest energy ligand position (preferred binding 120) with respect to the potential binding site 116.

The potential site component 106 can obtain a potential binding site 116 for a ligand 118 on a surface of a macromolecule 114. In an embodiment, the potential binding site 116 can be predefined by a user (e.g., according to an input) or predefined according to a historical simulation (e.g., by an “artificial intelligence” algorithm based on examining a historical execution of the fast macromolecule-ligand algorithm with respect to the specific macromolecule 114). In another embodiment, the potential site component 106 can search the entire macromolecule 114 surface or part of the macromolecule 114 surface. In this case, the solvent accessible surface (SAS) of a protein is calculated. The coordinates of the surface points as well as the solvent accessible atoms are then identified. The atoms without any surface point are regarded as solvent inaccessible. Generally, atoms on the outside of a molecule are solvent accessible atoms and those on the inside of the molecule are not solvent accessible atoms. The one or more of the solvent accessible atoms can be chosen as the potential binding site 116.

The identification component 108 can identify donor atoms and acceptor atoms on both the potential binding site 114 and the ligand 116. In an embodiment, the donor atoms and acceptor atoms are hydrogen bond donors and hydrogen bond acceptors. An intermolecular hydrogen bond is composed of a donor atom (D) and a hydrogen atom (H) in one molecule, and an acceptor atom (A) in the other molecule. The donor atom most be bonded to a hydrogen atom, while the acceptor atom is not necessarily bonded to a hydrogen atom. The match of hydrogen and acceptor is assumed to be one-to-one, but multiple hydrogen atoms can be matched to a donor atom. The identification component 108 assumes that only those defined donor and acceptor atoms on the ligand 116 and those belonging to the potential binding site 114 (e.g., SAS atoms of the macromolecule) are capable of intermolecular interaction.

Examples of donors on a ligand 116 can include nitrogen atoms and sp³ hybridized oxygen atoms with mnemonic code O.3. Examples of acceptors on a ligand 116 can include all forms of oxygen atoms and nitrogen atoms.

Examples of hydrogen bond donor atoms of a macromolecule (e.g., a protein in this example) can be: (1) N (main chain N—H); and (2) HIS, NE2, HIS ND1, LYS NZ, ASN ND2, GLN NE2, ARG NN, ARG NH1, ARG NH2, SER OG1, TYR OH, TRP NE1, and ASN OD1. Examples of hydrogen bond acceptor atoms of a macromolecule (e.g., a protein in this example) can be (1) O (main-chain C=O); and (2) ASP OD1, ASP OD2, GLU OE 1, GLU OE2, ASN OD1, GLN OE1, SER OG, THR OG1, TYR OH, HIS ND1, GLU NE2, and ASN ND2. (All examples of donors and acceptors from the macromolecule are represented by their respective protein data bank (PDB) name code. Alpha carbon atoms, aromatic ring acceptors, NH a donors and sulfur atoms are relatively weak and not included.)

The relaxation labeling component 110 can utilize a relaxation labeling technique to identify a set of potential matching pairs of donors and acceptors on both the potential binding site 114 and the ligand 116 based on a geometric constraint for conformation of a physico-chemical interaction between the ligand 116 and the potential binding site 114 In an embodiment the physico-chemical interaction is a hydrogen bond. In another embodiment, the physico-chemical interaction is two or more hydrogen bonds. Although hydrogen bonds are described in details herein, it will be understood that other physico-chemical interactions are within the scope of this application.

The geometric constraint for conformation of a hydrogen bond can be established by considering the geometry of a hydrogen bond, D-H . . . A. In this case, if a hydrogen bond is to be formed, then the acceptor most be positioned approximately 2.5-3.5 Angstroms from the donor such that the donor, the hydrogen atom and the acceptor are approximately collinear. The relaxation labeling component 110 can facilitate the attachment of an ideal acceptor to each hydrogen atom of a potential hydrogen bond donor. The ideal acceptor is collinear with the D, the H atom and about 2.8 Angstroms away from the D atom. Accordingly, the matching of donors and acceptors is converted to the matching of ideal acceptors and acceptors.

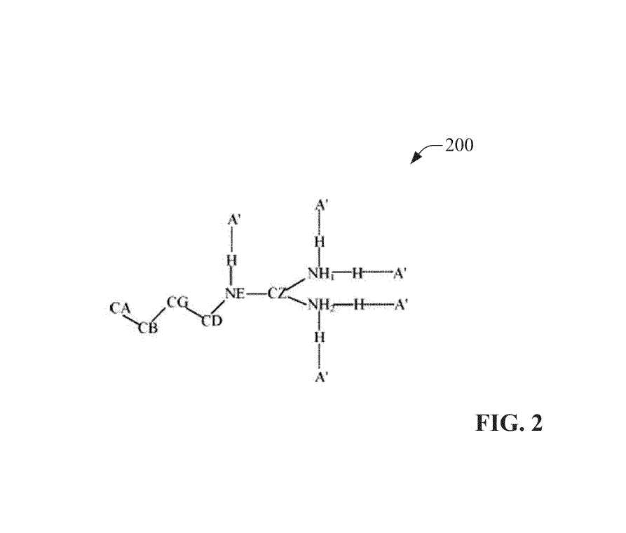

FIG. 2 shows a cartoon image 200 that illustrates five ideal acceptors (A′) that were added to five possible positions to the hydroxyl groups of serine, threonine, and tyrosine residues. Each ideal acceptor is about 2.8 Angstroms from a side chain N along the line of an N—H bond.

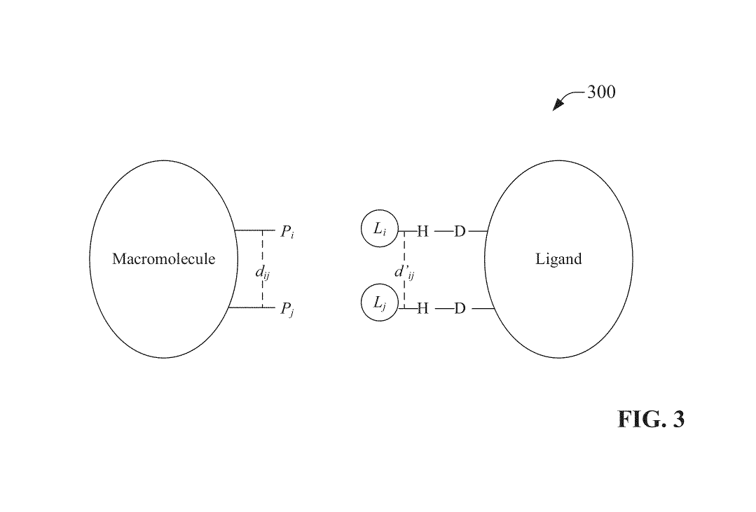

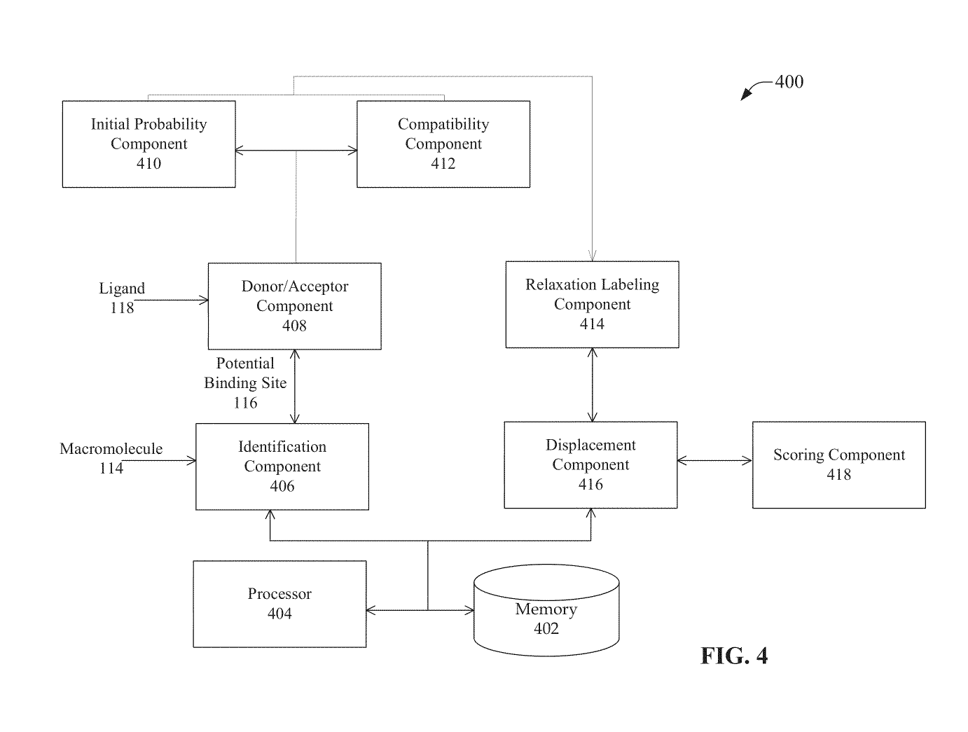

In an embodiment, the relaxation labeling component 110 assumes that two or more hydrogen bonds exist. If two hydrogen bonds are formed simultaneously between protein and ligand, they should satisfy certain conditions. An example of these conditions is shown in the cartoon image 300 FIG. 3, which considers two potential acceptor sites on the macromolecule and two potential donor sites on the ligand. It will be understood that the acceptor sites and the donor sites can occur on the protein or the ligand and not necessarily both on the same molecule. For example, a protein can have a donor and acceptor and the ligand can have an acceptor and a donor.

In the case where two hydrogen bonds are formed simultaneously as shown in FIG. 3, the distance (dᵢⱼ) between the acceptors Pᵢ and Pⱼ in the protein is the same as the distance dᵢⱼ′ between the ideal acceptors, Lᵢ and Lⱼ. in the ligand two within a tolerance (ε).

|dᵢⱼ−dᵢⱼ′|<δ

The tolerance (δ) can be user defined or can be set by the relaxation labeling component 110. The size of the tolerance permitted in the distance matching influences the efficiency and the accuracy of the fast macromolecule-ligand docking algorithm. When the tolerance is too small, the true hydrogen bonds may be ignored. When the tolerance is too large, it allows many coexisting hydrogen bonds, making the fast macromolecule-ligand docking algorithm time-consuming. In an embodiment, the tolerance can be set to 2 Angstroms. However, the tolerance can be any value in the range from 0.1 Angstrom-5 Angstroms).

The coexistence condition requires potential intermolecular hydrogen bonds to have the angle ∠D-H . . . A close to 180° and the distance D . . . A close to 2.8 Angstroms. Under a rigid transformation (i.e., translation and rotation), the distance between any point pair in a macromolecule or a ligand is preserved. Accordingly, this coexistence condition is not relevant to the relative position of the ligand to the protein.

System 400 can facilitate the execution of the fast macromolecule-ligand docking algorithm in situations where the ligand 114 is assumed to be rigid and also in situations that incorporate ligand flexibility. The flexible ligand can be examined as a number of conformations of the ligand where each conformation is represented as a rigid model. Although only situations where the macromolecule is rigid are discussed, it will be understood that system 400 can also be utilized when the macromolecule is considered to be flexible.

System 400 includes a memory 402 that can store instructions, components, or the like. System 400 also includes a processor 404 that can execute or facilitate execution of the instructions, components, or the like to facilitate the performance of various operations associated with the instructions, components, or the like. The memory 402 and the processor 404 are both hardware devices that can be utilized within a computing device. Memory 402 and processor 404 can be part of a single device or distributed through different devices.

The memory 402 can store various components, whose execution can be facilitated by the processor 404. The components include at least an identification component 406, a donor/acceptor component 408, an initial probability component 410, a compatibility component 412, a relaxation labeling component 414, a displacement component 416 and a scoring component 416.

The identification component 406 can facilitate identification of potential binding sites 116 on the surface of the macromolecule 114. An example of a potential binding site 116 on the surface of a protein is a cavity or pocket on the surface of the protein. A pocket detection tool that can be used for this process is Fpocket. The donor/acceptor component 408 can represent the potential binding site 116 and the ligand 118 as a series of potential hydrogen bond donors and acceptors, based on the hydrogen bond model. In order to find the matching between the donors and acceptors, a relaxation labeling scheme is carried out by considering the donors and acceptors as labels and objects, respectively, both on the ligand 118 and on the potential binding site 116. The initial probability component 410 introduces the local patch histogram to estimate the initial probability. The compatibility component 412 can compute the compatibility coefficient based on the hydrogen bond coexistence criterion which is illustrated in FIG. 3. The relaxation labeling component 414 can identify matching pairs after relaxation labeling. The displacement component 416 locates the ligand position based on a quaternion framework for each matching. The scoring component 410 utilizes a simplified scoring function considering van der Waals interaction and the number of hydrogen bond to evaluate the docked conformations of the complex.

In the embodiment where the macromolecule is a protein, system 400 builds on the hydrogen bond model and relaxation labeling scheme. Generally, a potential docking pocket is found on the protein (e.g., with a tool called Fpocket) by the least an identification component 406. Then on both the pocket and the ligand, the donor and acceptor atoms are identified by the donor/acceptor component 408. According to the geometric constraint for the conformation of hydrogen bond, relaxation labeling is utilized to identify the potential matching pairs on both the protein and ligand by the initial probability component 410 and the compatibility component 412, the relaxation labeling component 414. Then, a scoring function is used by the scoring component 418 for ranking those ligand positions obtained from displacement component 416 in order to identify the smallest energy ligand position.

A general description of the relaxation labeling employed by system 400 (the initial probability component 410, the compatibility component 412, the relaxation labeling component 414, and the displacement component 416) is now described.

The relaxation labeling is based on the nonlinear probabilistic relaxation model. For two data sets, object data set O={O₁, O₂, . . . Oₙ} representing the data to be labeled and label date set L={L₁, L₂, . . . , Lₘ} representing the labels for each object, three parts of the relaxation scheme can be estimated.
1. The weight tᵢⱼ of the influence of one object Oᵢ from others Oⱼ is calculated. The weight should meet the requirement that Σⱼ₌₁ⁿtᵢⱼ=1.
2. For each object Oᵢ, a set of initial probabilities P⁽⁰⁾(Oᵢ,Lᵤ), u=1, 2, . . . m, of label assignment should be estimated. The initial probabilities should satisfy the condition that:

Σᵤ₌₁^{m}P⁽⁰⁾(Oᵢ,Lᵤ)=1
3. A compatible matrix Rᵢⱼ with size m×m should also be estimated for each pair of objects Oᵢ and Oⱼ. The element rᵢⱼ(Lᵤ,Lᵥ) in Rᵢⱼ representing the compatibility of labeling Lᵤ on object Oᵢ with Lᵥ on the object Oⱼ should satisfies the condition:

$$\{ \begin{matrix}0 < {r}_{ij} ( {L}_{u} , {L}_{v} ) \leq 1 & {L}_{u} and {L}_{v} are compatible \\ {r}_{ij} ( {L}_{u} , {L}_{v} ) = 0 & otherwise .\end{matrix}$$

In the relaxation scheme, an iteration process is carried on through updating the probability and the correction of the system in order to achieve a globally consistent result. The probability of matching Lᵤ to Oᵢ at the (k+1)th iterations are:

$${P}^{( k + 1 )} ( {O}_{i} , {L}_{u} ) = \frac{{P}^{( k )} ( {O}_{i} , {L}_{u} ) [ 1 + {Q}^{( k )} ( {O}_{i} , {L}_{u} ) ]}{{\sum }_{s = 1}^{m} {P}^{( k )} ( {O}_{i} , {L}_{s} ) [ 1 + {Q}^{( k )} ( {O}_{i} , {L}_{s} ) ]}$$

$$where$$

$${Q}^{( k )} ( {O}_{i} , {L}_{u} ) = {\sum }_{j = 1}^{n} {t}_{ij} ( {\sum }_{v = 1}^{m} {r}_{ij} ( {L}_{u} , {L}_{v} ) {P}^{( k )} ( {O}_{j} , {L}_{v} ) )$$

After several iterations, the matching pair between the two data sets can be obtains through final probability matrix in which labeling Lᵤ on Oᵢ obtain a much larger probability. For the relaxation labeling scheme the main problems are the estimation of the initial probability and the calculation compatible matrix. In system 400, relaxation labeling is used with the matching processing between the macromolecule 114 and the ligand 118. According to a biological model, the initial probability and the compatible matrix are subsequently estimated.

In the following description, the macromolecule is a protein. As donors and acceptors are on the protein pocket and ligand, donors and acceptors on the ligand are assumed to be a set of objects O={O_{d1} O_{d2} . . . O_{dr}, Oₐ₁ Oₐ₂, . . . , Oₐₛ} and donors and acceptors on the protein pockets are assumed to be a set of labels L={L_{d1} L_{d2}, . . . L_{dp}, Lₐ₁ Lₐ₂, . . . , L_{aq}}. The subscript d and a are used to discriminate donors and acceptors, because donors on the ligand can only be labeled on acceptors on the protein pocket and acceptors on the ligand can only be labeled on the donors on the protein pocket. The influence weights on one object from others are considered as equal.

The local patch histogram of hydrogen bond for is used to facilitate the initial probability estimation. The first step in procedure is to generate solvent accessible dot molecular surface as well as the unit surface normal with DMS. Then, for each donor/acceptor, a local patch is defined around the atom center. The surface points that are within a distance ranges between 2.5 Å and 3.6 Å away from one donor/acceptor atom center can be made up of a local patch of the donor/acceptor. The normal of the patch are the average value of all the normal of the surface point on this patch.

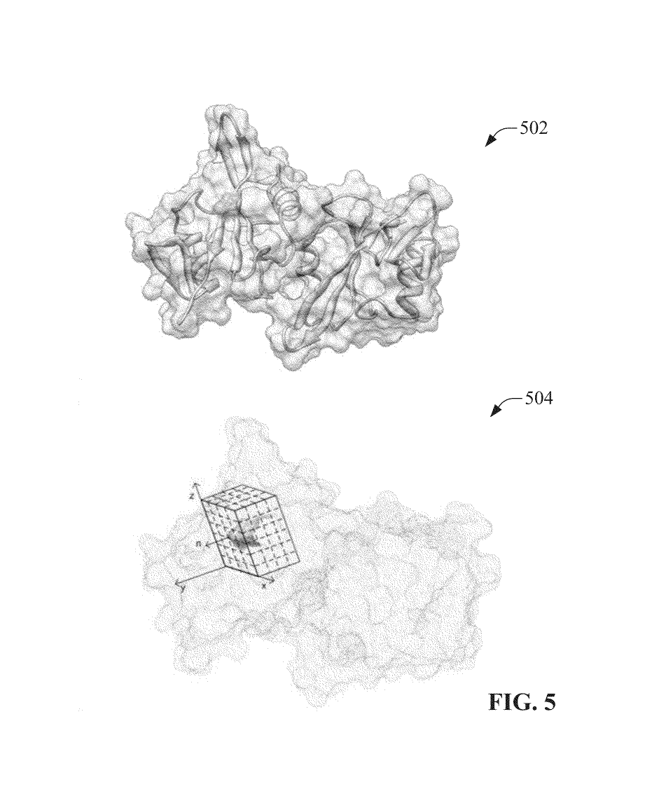

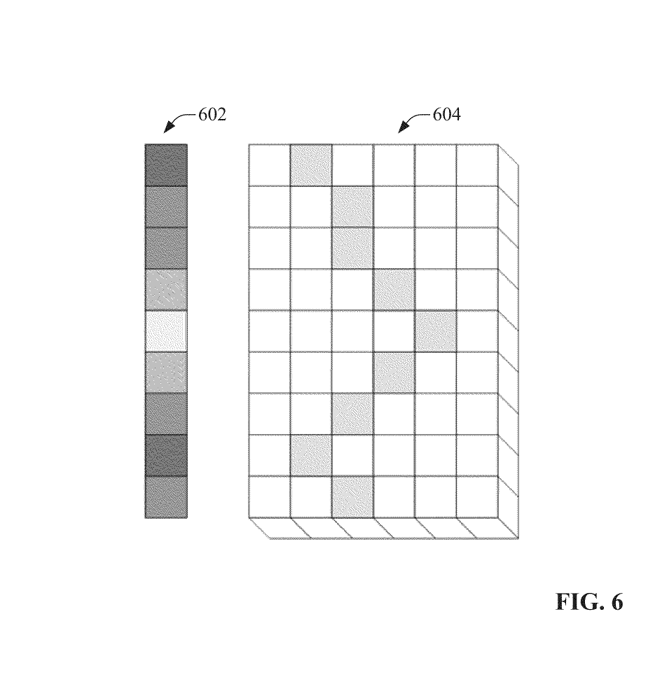

FIG. 5 illustrates construction of the local patch histogram. The surface point of local patch for donor/acceptor atom corresponding to a potential hydrogen bond is shown at element 502. At 504, the three dimensional volume construction for the local patch is illustrated. FIG. 6 shows the three dimensional surface projections. At element 604, the dark cells indicate the surface point of the three dimensional structure. The projected two dimensional image after projection along the y-axis direction is shown at element 602, with gray scale representing the height of the histogram.

A rectangular three dimensional volume centered at the atom center with four edges parallel to the patch norm and the other eight edges perpendicular to the patch norm can be considered. The three dimensional volume is composed of cubical bins with size of 1 Å and the number of bins is 10 for each direction. Thus the three dimensional volume intersects the dot surface and the intersections are marked, as shown in FIG. 5, element 502.

Then the three dimensional point patch is turned into a two dimensional grid image by projecting the points along the patch norms. A local coordinate system can be built with the origin at the left bottom of the back of the volume corner. The x,y,z axes are along the volume edges, as shown in FIG. 5, element 504. For each xz cell, the bin xy′z is defined to be outside if there exists a bin that intersects the surface points, with y′ larger than y. The two dimensional image xz pixel histogram value is then the number of outside bins that correspond to xz, which can indicate the distance between the surface points of protein/ligand structure to the face of the three dimensional volume.

FIG. 6 shows the three dimensional projection process. The grey levels in the two dimensional image (element 604) show the height of the histogram. The brighter the pixel is, the larger distance it represents between the dot surface to the volume face. When there is not only one surface point located in the same bin Bᵢ, the point Pᵢ is chosen with the coordinate most near to the average of the points in all bins which can be expressed as:

$${P}_{i} = arg {min}_{σ ∈ {B}_{i}} \vert {P}_{σ} - \overline{{P}_{σ}} \vert .$$

The histogram of local patch can provide us a way to find the shape complimentary pair of the donor and acceptor. When the initial probability of the matching pair is computed, the local patch normal of the donor/acceptor is reversed on the ligand and the normals on the protein remain unchanged.

Keeping the center of the atom for the hydrogen bond pair (donor/acceptor) at the same point, the local patch is rotated on the ligand until the patch norm is in the same direction with the local patch norm on the protein. Then the three dimensional patch is turned into a two dimensional image by projection. Thus through measuring the similarity of pairs of patch histograms, the initial probability can be obtained.

A modified Manhattan distance that differentiates between surfaces gaps and overlaps is defined. A gap is a location in which the surfaces fail to meet and overlaps are location which the surfaces interpenetrate. For the given two patch histograms, P₁ from protein and P₂ from ligand, the modified Manhattan distance between them is:

$$\begin{matrix}d = ( A , \overline{B} ) \\ = d ( \overline{B} , A ) \\ = {\sum }_{ij}^{ } d ( {a}_{ij} , {\overline{b}}_{ij} )\end{matrix}$$

where the summation extends over all bins ij under the condition that the value of that bin is a non-zero element in the 2D image with each bin distance defined as:

$$d ( {a}_{ij} , {\overline{b}}_{ij} ) = \{ \begin{matrix}( {a}_{ij} - {\overline{b}}_{ij} ) & {a}_{ij} \geq {\overline{b}}_{ij} \\ β ( {\overline{b}}_{ij} - {a}_{ij} ) & {a}_{ij} < {b}_{ij} ,\end{matrix}$$

where β is a user-defined parameter between 0 and 1 representing the penalty for gaps relative to overlaps. In an embodiment, β=0.1. The similarity between the local patch can be represented by the local modified Manhattan distance. If the differences are small, the two local patches are similar and vise versus. The projected 2D image of the ligand patch can be rotated with 30 increments around the center in order to get the largest similarity. It can be assumed that the two similar patches have a large probability to perform a hydrogen bond. Thus the initial probability for the matching between donor/acceptor on the ligand and acceptor/donor on the protein is defined as:

$$P ( i , j ) = exp ( - {d}^{α} ) = exp ( - {\{ {\sum }_{ij} d ( {a}_{ij} , {\overline{b}}_{ij} ) \}}^{α} )$$

In an embodiment, α=0.9 and the initial probability for the donor-donor/acceptor-acceptor pairs are all 0.

Two hydrogen bonds can coexist under the condition that |dᵢⱼ−dᵢⱼ′|≦2 Å, where dᵢⱼ represents the distance between the acceptors on the protein and dᵢⱼ′ represents the distance between the ideal acceptors on the ligand (FIG. 3). The compatible coefficient matrix can be created according to this criterion as well as the pairwise affinities obtain from geometric local isometry. In pairwise assignment, the pairwise affinity measure can score the simultaneous matching of cᵢᵢ and cⱼⱼ implying that Oᵢ is matched to Lᵢ and Oⱼ to Lⱼ simultaneously. According to the local isometry, the pairwise affinities can be liven by:

$$\begin{matrix}Ω ( {c}_{ii} , {c}_{jj} ) = Ω ( \{ {O}_{i} , {L}_{i} \} , \{ {O}_{j} , {L}_{j} \} ) \\ = exp ( - \frac{1}{{ξ}^{2}} \vert \vert {O}_{i} - {O}_{j} \vert - \vert {L}_{i} - {L}_{j} \vert \vert ) \\ = exp ( - \frac{1}{{ξ}^{2}} \vert {d}_{ij} - {d}_{ij}^{′} \vert )\end{matrix}$$

Combining the hydrogen bond coexistence criterion:

$$r ( {c}_{ii} , {c}_{jj} ) = \{ \begin{matrix}0 & \vert {d}_{ij} - {d}_{ij}^{′} \vert > 2 \\ - exp ( \frac{1}{{ξ}^{2}} \vert {d}_{ij} - {d}_{ij}^{′} \vert ) & \vert {d}_{ij} - {d}_{ij}^{′} \vert \leq 2\end{matrix}$$

If two hydrogen bonds can be formed simultaneously, object Oᵢ can be labeled with Lᵢ and object Oⱼ can labeled with Lⱼ, then the compatibility coefficient r(cᵢᵢ,cⱼⱼ)=Ω(cᵢᵢ,cⱼⱼ). Similarly, if the two hydrogen bonds cannot coexist, then the compatibility is set to zero. In an embodiment, ξ=1. After the estimation of the initial probability as well as the compatible matrix, an updating process is carried on.

The final probability which can indicate the matching pair can be given. All the weights of influence on one object from the other are assumed to be equal, thus tᵢⱼ=1/r+s. The matching is ambiguous according to the initial probability, however after the relaxation labeling updating process, almost all the matching probabilities converge to one or zero. In the condition that donors on ligand cannot match to donors on protein pocket, so the compatibility coefficient is also zero (the same is true with regard to the acceptor-acceptor pairs). The relaxation labeling procedure is summarized as follows:

The relaxation labeling algorithm for hydrogen bond matching
Input: O={O_{d1} O_{d2} . . . O_{dr}, Oₐ₁ Oₐ₂, . . . , Oₐₛ} the acceptors and donors on ligand
   L={L_{d1} L_{d2}, . . . L_{dp}, Lₐ₁ Lₐ₂, . . . , L_{aq}} the donors and acceptors on protein
Output: M: matching matrix indicator
   1. Compute the initial probability for each pair of matching and build the initial probability matrix
   2. Estimate the compatibility matrix with the coexistence condition
   3. Update the correction equation with tᵢⱼ=1/r+s, then update the probability
   4. Repeat step 3 until |P^{(k+1)}(Oᵢ, Lᵢᵢ)−P^{(k)}(Oᵢ,Lᵢᵢ)|≦10⁻⁶

After relaxation labeling, final matching indicator matrix can be obtained. Objects with matching probability larger than Qₘᵢₙ will be labeled and other matching pair will be deleted. In an embodiment, Qₘᵢₙ=0.5. Since there are more labels than objects, one object may have more than one label. All conditions are considered, in an embodiment, but fewer than all conditions may be considered.

One matching mode indicates the match pairs between ligand and protein pockets can be written as {(O₁,L₁), (O₂,L₂), . . . (O_{K},L_{K})}, where K is always smaller than ten in the experiment. As the true conformation of the complex may be missed by only considering the whole hydrogen bond mode set, the subset of the matching pairs is also considered. However, the computational complexity increases to 2^{K} for each mode with K matching pairs. Given that the ligand position can be identified with three hydrogen bonds performed between protein pocket and ligand, the subset of matching mode is only considered with 3 matching pairs, which can obviously reduce the computational cost. However, using only 3 matching pairs may reduce the accuracy.

For the mode with matching pair, no more than two, all the subsets, as well as the whole matching mode set, are considered. Thus all the matching modes contain three matching pairs at most and for the mode with one or two matching pairs, rotation should be taken into considerations.

Experimentally, it was discovered that the mode set contains only hundreds of modes or even fewer. Therefore, potential ligand position identification and computation of the scoring functions for these modes after matching can be carried out efficiently.

Upon identification of the matching pairs of donors and acceptors, the ligand position relative to protein can be obtain through superposing protein and ligand according to the predicted hydrogen bond mode. The hydrogen bond mode set that contains the matching pair of donors and acceptors can be seen as two set of ordered points O_{match}={O₍₁₎, O₍₂₎, . . . , O₍ₖ₎} and L_{match}={L₍₁₎, L₍₂₎, . . . , L₍ₖ₎}, where O₍ᵢ₎ is bonded with L₍ᵢ₎, i=1, 2, . . . k. The ideal acceptors added to hydrogen atoms of potential hydrogen bond donors are used to represent the hydrogen bond donors for superposing protein and ligand. After a rigid transformation (rotation and translation) for O_{match}, the least root mean square error between two sets of points. Thus the potential ligand position identification problem can be formulated as (given two ordered set of point data, target set yₖ and model set xₖ, 1<k<N, system 400 tries to find an orthogonal rotation R and a translation T such that the RMSD error is minimized):

$$E = \sqrt{\frac{1}{N} {\sum }_{k = 1}^{N} \vert {Rx}_{k} + T - {y}_{k} \vert} .$$

The quaternion based best-fit RMSD algorithm is utilized. First the two sets {xₖ} and {yₖ} are shifted to their respective barycenters. The barycenter is defined as:

$$\overline{x} = \frac{1}{N} {\sum }_{k = 1}^{N} {x}_{k} , \\ \overline{y} = \frac{1}{N} {\sum }_{k = 1}^{N} {y}_{k}$$

So the shifted xₖ and yₖ can be expressed as

x_{kc}=xₖ− x̅,y_{kc}=yₖ− y̅

After the translation, the two set of data are all centered at origin. Thus the RMSD error can be given by

$$E = \sqrt{\frac{1}{N} {\sum }_{kc = 1}^{N} \vert {Rx}_{kc} - {y}_{kc} \vert}$$

To find the best R which can minimized E, x_{kc} and y_{kc} are promoted to pure quaternions, x_{kq}=(0,x_{kc}) with x_{kc}^{t}=−x_{kc} and y_{kq}=(0,y_{kc}) with y_{kc}^{t}=−y_{kc}. Thus the rotations on R(q) on x_{kc} is than written as (0,R(q)x_{kc})=qx_{kc}q^{t}. Then the RMSD errors can be written in terms of quaternions as:

$${E}_{q} = \sqrt{\frac{1}{N} {\sum }_{kc = 1}^{N} ( {qx}_{kc} {q}^{t} - {y}_{kc} ) {( {qx}_{kc} {q}^{t} - {y}_{kc} )}^{t}}$$

The rotations on R(q) on x_{kc} is than written as (0,R(q)x_{kc})=qx_{kc}q^{t}, such that:

$$\begin{matrix}{NE}_{q}^{2} = {\sum }_{kc = 1}^{N} ( ( {qx}_{kc} {q}^{t} ) {( {qx}_{kc} {q}^{t} )}^{t} + {y}_{kc} {y}_{kc}^{t} - ( {qx}_{kc} {q}^{t} ) {y}_{kc} - {{y}_{kc} ( {qx}_{kc} {q}^{t} )}^{t} ) \\ = {\sum }_{kc = 1}^{N} ( {x}_{kc} {x}_{kc}^{t} + {y}_{kc} {y}_{kc}^{t} + ( {qx}_{kc} {q}^{t} ) {y}_{kc} + {y}_{kc} ( {qx}_{kc} {q}^{t} ) )\end{matrix}$$

According to the properties of quaternions:

qx_{kc}q^{t}y_{kc}+y_{kc}(qx_{kc}q^{t})=2[y_{kc}(qx_{kc}q^{t})]₀=−2q^{T}Fq

In terms of the matrix elements of the correlation matrix C, the explicit form of the matrix F can be expressed as:

$$F = ( \begin{matrix}{C}_{11} + {C}_{22} + {C}_{33} & {C}_{23} - {C}_{32} & {C}_{31} - {C}_{13} & {C}_{12} - {C}_{21} \\ {C}_{23} - {C}_{32} & {C}_{11} - {C}_{22} - {C}_{33} & {C}_{12} - {C}_{21} & {C}_{13} - {C}_{31} \\ {C}_{31} - {C}_{13} & {C}_{12} + {C}_{21} & - {C}_{11} + {C}_{22} - {C}_{33} & {C}_{23} + {C}_{32} \\ {C}_{12} - {C}_{21} & {C}_{13} + {C}_{31} & {C}_{23} + {C}_{32} & - {C}_{11} - {C}_{22} + {C}_{33}\end{matrix} )$$

In which the correlation matrix of x_{kc} and y_{kc} can be obtained by:

$${C}_{ij} = {\sum }_{kc = 1}^{N} {x}_{ikc} {y}_{jkc}$$

The problem is now finding the maximum value of q^{T}Fq in the four variables qᵢ, with constrain q^{T}q=1. According to the Rayleigh quotient, the maximum value achieved by q^{T}Fq is equal to its largest eigenvalue of F. Thus the best-fit RMSD error can be written as

$${E}_{q} = \sqrt{\frac{{\sum }_{kc = 1}^{N} ( {\vert x \vert}_{kc}^{2} + {\vert y \vert}_{kc}^{2} ) - 2 {λ}_{max}}{N}}$$

The rotation matrix is given by

$$R ( q ) = ( \begin{matrix}{q}_{0}^{2} + {q}_{1}^{2} - {q}_{2}^{2} - {q}_{3}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{0}^{2} - {q}_{1}^{2} + {q}_{2}^{2} - {q}_{3}^{2} & 2 ( {q}_{2} {q}_{3} - {q}_{0} {q}_{1} ) \\ 2 ( {q}_{1} {q}_{3} - {q}_{0} {q}_{2} ) & 2 ( {q}_{2} {q}_{3} + {q}_{0} {q}_{1} ) & {q}_{0}^{2} - {q}_{1}^{2} - {q}_{2}^{2} + {q}_{3}^{2}\end{matrix} )$$

With the quaternions, the rotation matrix can be obtained. As the two set of points have been moved to the origin, at the last step they all should be translated back to where the protein located. Thus the final position of the bonded ligand can be computed through the rigid transformation.

The scoring function employed by system 400 (the scoring component 418) is now generally described. A list of candidate docking results that indicate the relative position of the ligand is generated after the displacement process of the ligand. The scoring function is used to rank the result in order to obtain the optimal docked complex with least RMSD with the experiment result. The van der Waals interaction between protein and ligand represented by potential in related with distance between atoms can be simplified as follows:

$${G}_{{VDW}_{mn}} = \{ \begin{matrix}0 & {d}_{mn} \geq {d}_{0} \\ {d}_{0} - {d}_{imn} & {d}_{mn} < {d}_{0}\end{matrix} ,$$

where dᵢⱼ is VDWₘₙ represents the potential between atom m and n, dₘₙ is the distance between atom center m and n, and d₀ is the sum of van der Waals radii of two atom which is set to be 1.7 Å for one atom. The total potential between protein and ligand is the summation between all heavy atoms between the protein and ligand. The hydrogen bond interactions are also considered since the intermolecular hydrogen bond can make the whole complex more stable. So on the whole, the scoring function can be defined as follows:

$$S F = {\sum }_{m}^{protein} {\sum }_{n}^{ligand} {G}_{{VDW}_{mn}} - {N}_{HBond} ,$$

where N_{Hbond} is the total intermolecular hydrogen bond of the predicted mode of the complex. When the number of the hydrogen bonds is small, the effect of hydrogen bond is weak. However, the effectiveness of the hydrogen bond interaction becomes obvious, when the number of the hydrogen bond becomes larger.

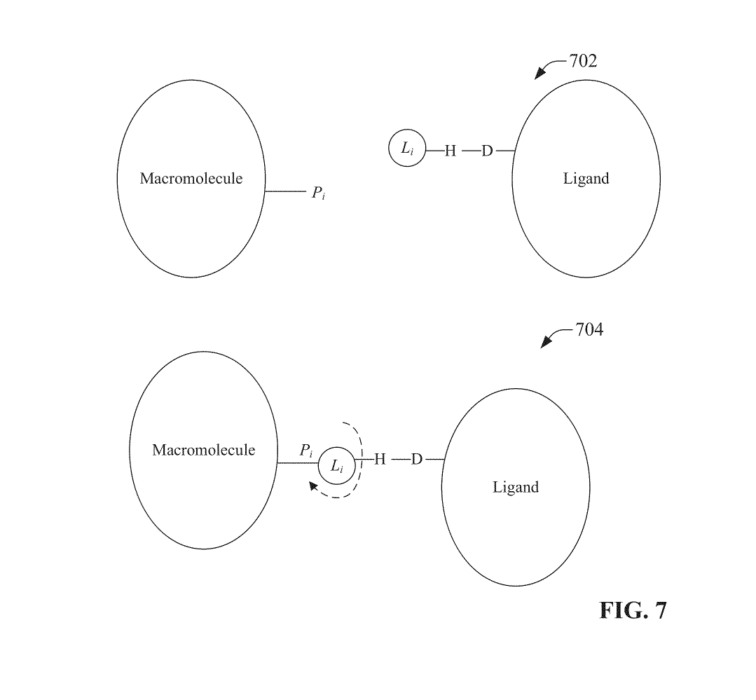

Particular attention should be paid to the relaxation labeling component 110 in special cases where only one or two hydrogen bonds are formed between the macromolecule and the ligand. FIG. 7 illustrates one hydrogen bond only, where Pᵢ matches to Lᵢ in element 702. The ligand will be located at a position to make Lᵢ coincide with Pᵢ. However, the position of the ligand relative to the macromolecule is not unique since the ligand can rotate around Pᵢ freely when Lᵢ coincides with Pᵢ. To handle this issue, rotations around x, y, z axis are taken every 30° to generate all possible ligand positions. The number of these possible predictions is very large, so an extra restriction is needed. The angle D-A . . . AA must be greater than 90° where AA represents another atom bonded to the acceptor.

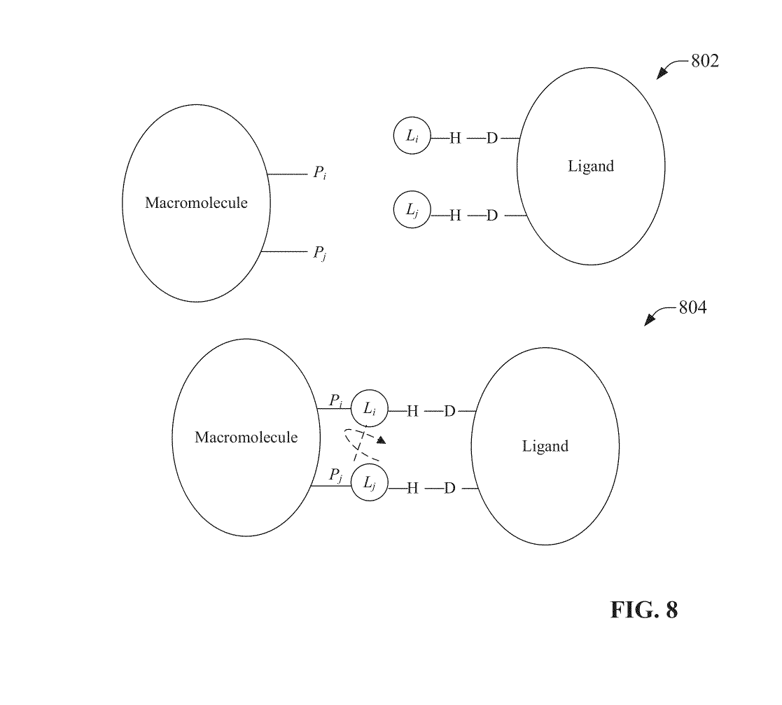

A similar restriction is imposed when two hydrogen bonds are formed, where the ligand can rotate freely around the axis that passes through two potential hydrogen bonding sites. An example is shown in FIG. 8, in which both pairs of points are as close as possible in 802, but the ligand can rotate freely around the axis that passes through the two potential bonding sites in 804. The increment for rotation around x, y, z axis is 30° to generate all possible ligand positions.

The rapid grid based technique for van der walls potential evaluation is adopted to speed up the searching. A docking zone is defined to be a cube with 30 Å on each edge centered on the pocket center of the protein. It is split by grid maps with 121×121×121 bins with each bin size of 0.25×0.25×0.25 Å. The van der Walls potential between the center of these bins and the whole protein is calculated and stored. The pre-calculated value for each atom in the ligand can be retrieved from the bins where the atom is located it is needed to compute the scoring function of a specific protein-ligand interaction.

The technique described above can be efficiently applied to the situation where the ligand is assumed to be rigid. However, in the real condition some rotatable bonds exist in the ligand which may lead to the flexibility of ligand. Thus in practice, the flexible docking is more proper to identify complex conformation accurately. For the flexible ligand case, an ensemble of conformations for the ligand is generated and the rigid docking is applied with each conformation treated as a rigid one. Then system 400 can operate as illustrated above to identify the ligand position for each conformation and the scoring function can be computed to sort the potential docking result.

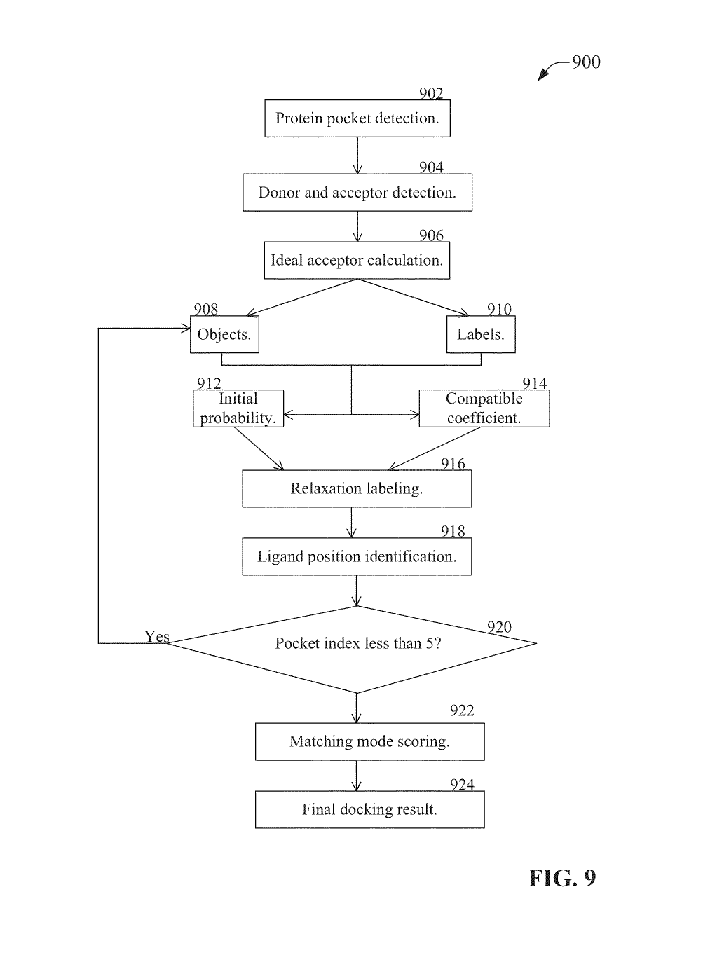

FIG. 9 illustrates a method 900 that can facilitate the determination of preferred macromolecule-ligand docking positions. For simplicity of explanation, the methods (or procedures) are depicted and described as a series of acts. It is to be understood and appreciated that the various embodiments are not limited by the acts illustrated and/or by the order of acts. For example, acts can occur in various orders and/or concurrently, and with other acts not presented or described herein.

FIG. 9 is an example non-limiting process flow diagram of a method 900 that facilitate fast discovery of potential macromolecule-ligand docking positions, according to an aspect or embodiment of the subject disclosure. In FIG. 9, the macromolecule is a protein.

Method 900 is based on hydrogen bond matching and probabilistic relaxation labeling. In FIG. 9, the ligand is assumed to be rigid. However, the docking process can introduce flexibility of the ligand. For example, with a flexible ligand, an ensemble of conformations of the ligand can be generated and each conformation can be treated as a rigid ligand.

At element 902, the protein pocket is detected. In the detection, the pocket structure on the protein is identified and the top five result is selected. To detect the protein pocket, the solvent accessible surface (SAS) are of the atoms of the protein can be calculated and potential binding sites can be identified.

At element 904, the donor and acceptor atoms are detected. In other words, the donor, hydrogen and acceptor atoms are identified on both the protein pockets and ligand. The donor atoms and acceptor atoms are atoms that are capable of intermolecular hydrogen bond interaction.

At element 906, an ideal acceptor is added to each hydrogen of a potential hydrogen bond donor. For each of the pockets and the ligand, the ideal acceptor position of each potential hydrogen bond donors is calculated. The donor positions can be replaced by the corresponding ideal acceptor positions for the matching process. At element 908, a set of objects is created with donors and acceptors on the protein pocket. At element 910, a set of labels is created with donors and acceptors on the ligand. At element 912, the initial probability is estimated by the local patch histogram of hydrogen bond donor and acceptor atoms. At element 914, the compatible coefficient matrix is matrix is estimated. At 916, the relaxation labeling process is undergone to compute the potential hydrogen bond matching pairs based on the initial probability and the compatible coefficient. At element 96, for each mode generated by relaxation labeling, the ligand position is identified. The ligand position can be identified based on a quaternion best-fit RMSD algorithm. In other words, for each mode generated by relaxation labeling, a displacement of the ligand is formulated as the optimization problem and solved by applying the a quaternion best-fit RMSD algorithm. Acts 908-918 can be repeated until all of the top five protein pockets are considered at element 920. The top five protein pockets are ensured to be considered by the pocket index being less than five.

At element 922, the value of the scoring function for each docked complex is determined (also referred to as matching mode scoring). For example, the scoring function can be:

$$S F = {\sum }_{m}^{protein} {\sum }_{n}^{ligand} {G}_{{VDW}_{mn}} - {N}_{HBond} ,$$

where N_{Hbond} is the total number of intermolecular hydrogen bonds of the predicted mode of the complex.

The value of the scoring function can be sorted for each docked complex. At element 924, the docked complex with the minimum value of the sorting function is chosen as the final docking result.

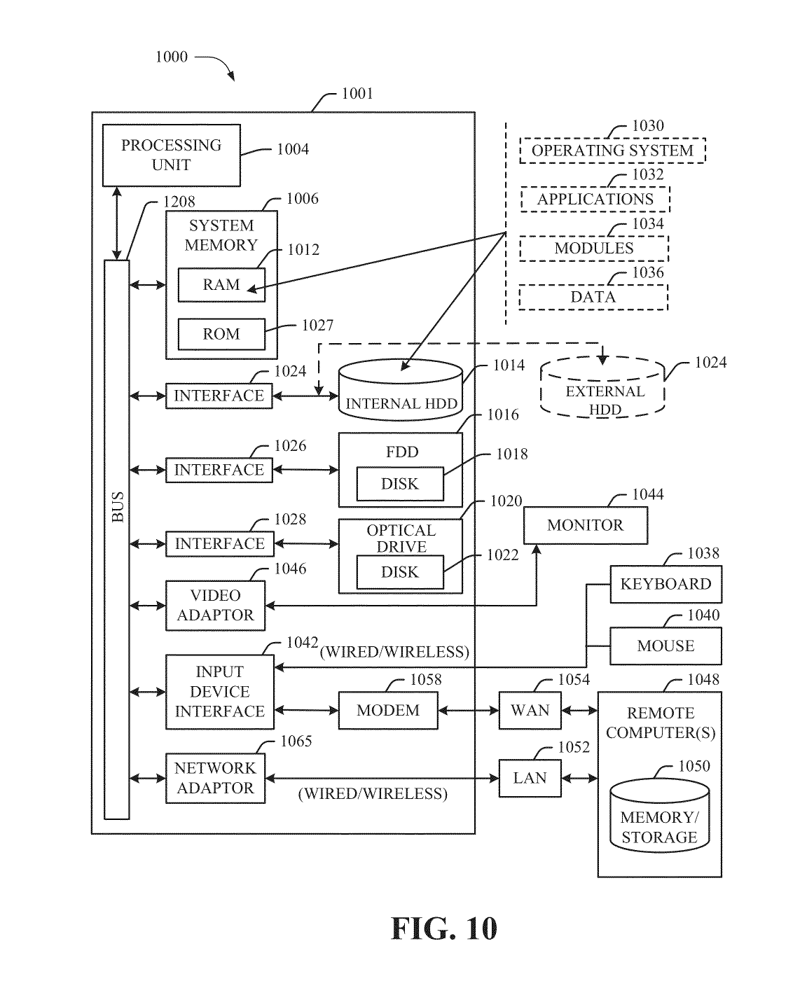

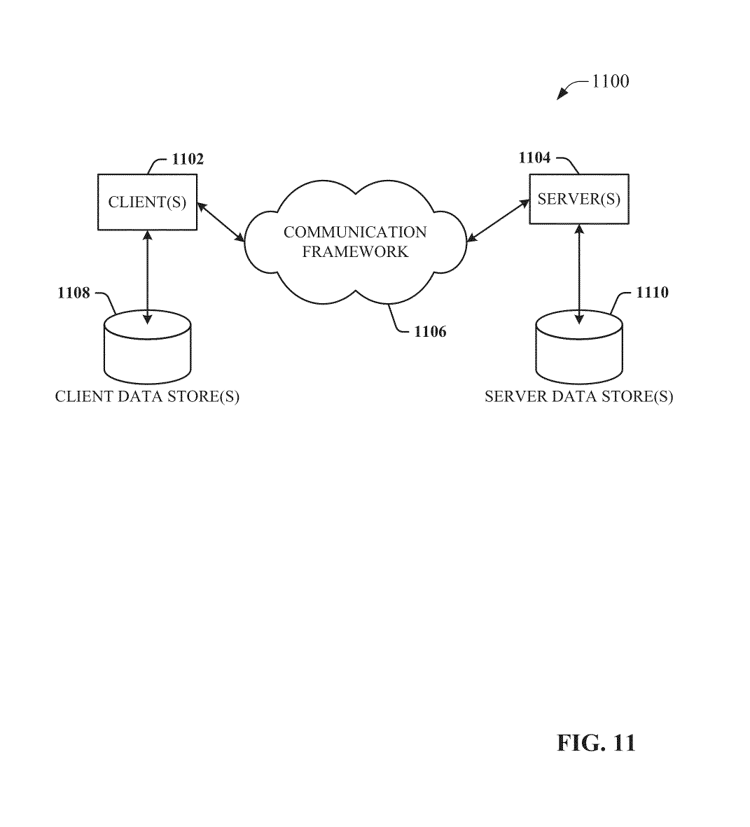

In order to provide a context for the various aspects of the disclosed subject matter, FIGS. 10 and 11, as well as the following discussion, are intended to provide a brief, general description of a suitable environment in which the various aspects of the disclosed subject matter can be implemented. As a non-limiting example, the systems and methods that employ the fast macromolecule-ligand docking algorithm can be executed at least in part via a computer with a dual core processor with CPU 2.8 GHz and 8G RAM. However, it will be understood that the systems and methods described herein can utilize any computing device, any processor, and any memory that can facilitate execution of the fast macromolecule-ligand docking algorithm.

With reference to FIG. 1010, an example computing environment 1210 that can be utilized to facilitate implementing various aspects of the aforementioned subject matter. The environment 1010 includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Multi-core microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable PROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 generally includes any computer recording media that includes a recording media to retain digital data. Disk storage 1024 includes, but is not limited to, devices like a magnetic disk drive, floppy disk drive, tape drive, magnetic drive, Jaz drive, Zip drive, LS-100 drive, solid state semiconductor drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that one or more embodiments of the subject disclosure can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, a touch screen, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL). Computer 1010 can also operate in a wireless network (e.g., WIFI).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, Ethernet cards and wireless modems and other wireless technologies.

FIG. 11 is a schematic block diagram of a sample-computing environment 1300 with which the disclosed subject matter can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

### EXPERIMENTAL

The feasibility of the systems and methods that can facilitate the prediction of the preferred position and orientation of a ligand bound to a macromolecule to form a stable complex based on matching of a physico-chemical property and probabilistic relaxation labeling is experimentally illustrated using a protein as the macromolecule and hydrogen bonds as the physico-chemical property. Hydrogen bond matching is described as the physico-chemical property, but these experimental results can be extended to matching of other physico-chemical properties.

Experimental results showing the feasibility of utilizing hydrogen bond matching and probabilistic relaxation labeling (and corresponding fast protein-ligand docking systems and methods) to predict the preferred position and orientation of a ligand bound to a macromolecule. The experimental results illustrate that the fast protein-ligand docking systems and methods employing hydrogen bond matching and probabilistic relaxation labeling can be applied to both rigid and flexible docking. The experimental results further illustrate that the fast protein-ligand docking systems and methods employing hydrogen bond matching and probabilistic relaxation labeling can achieve successful predictions, even when the number of the intermolecular hydrogen bonds is small, while being computationally efficient. Two testing data sets were used to validate the accuracy of the fast protein-ligand docking systems and methods employing hydrogen bond matching and probabilistic relaxation labeling. One data set treated the ligand as conformationally rigid during docking (rigid testing set), while the other dataset introduced some degree of flexibility during docking (flexible testing set). The protein was treated as conformationally rigid for both datasets. Although the side chain and backbone of the protein often move when they interact with the ligand, treating the protein as rigid for these experimental purposes provides good experimental results. More accurate results can be obtained by adding protein flexibility to the fast protein-ligand docking systems and methods employing hydrogen bond matching and probabilistic relaxation labeling. The experiments show, basically, that the fast protein-ligand docking algorithm as described above is an effective and efficient protein-ligand docking algorithm.

### Intermolecular Hydrogen Bonds

A geometric criterion was used to determine the number of intermolecular hydrogen bonds between the protein and the ligand in the native complexes of both the rigid and the flexible datasets. The geometric criterion is illustrated as follows:
Distance H . . . A less than 2.5 Å;
Distance D . . . A less than 3.9 Å;
Angles ∠D-H . . . A greater than 90°; and
All water molecules removed,
where H corresponds to a hydrogen atom, A corresponds to an acceptor atom, and D corresponds to a donor atom.

### Rigid Testing Set

The data set used for rigid docking (the rigid testing set) was the CCDC/Astex dataset collected by Nis sink et al., which was described at Nis sink et al. A new test set for validating predictions of protein-ligand interaction. Proteins: Struct Funct Bioinform 2002; 49: 457-471.

The dataset included 305 protein-ligand complexes, which were distributed among different protein families and had diverse ligand structures.

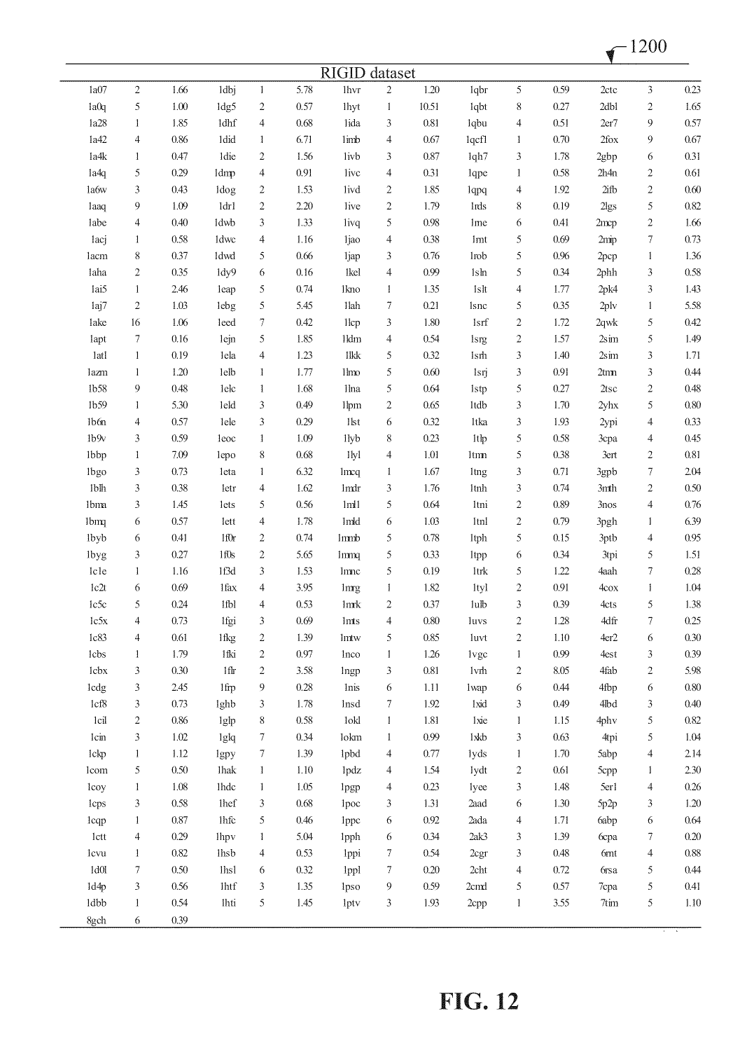

All of the data of the CCDC/Astex dataset were downloaded from http://www.ccdc.cam.ac.uk. The dataset provided the information of atoms on both proteins and ligands, including the 3D coordinates and the mnemonic codes. The Protein Data Bank (PDB) names of 251 testing cases, each of which has at least one hydrogen bond, the number of intermolecular hydrogen bonds and the RMSD value (Angstroms) in the experimentally determined docked complexes are illustrated in FIG. 12.

### Flexible Testing Set

The data set used for flexible docking was constructed by Wang et al., which was described at Wang et al. Comparative evaluation of 11 scoring functions for molecular docking. J Med Chem 2003; 46: 2287-2303.

The dataset included 100 protein-ligand complexes, which were distributed among 43 different types of proteins. For each of the complexes, the 100 docked conformations generated by AutoDock were added to the experimentally observed conformation of the ligand. The total number of docked conformations of each ligand thus became 101.

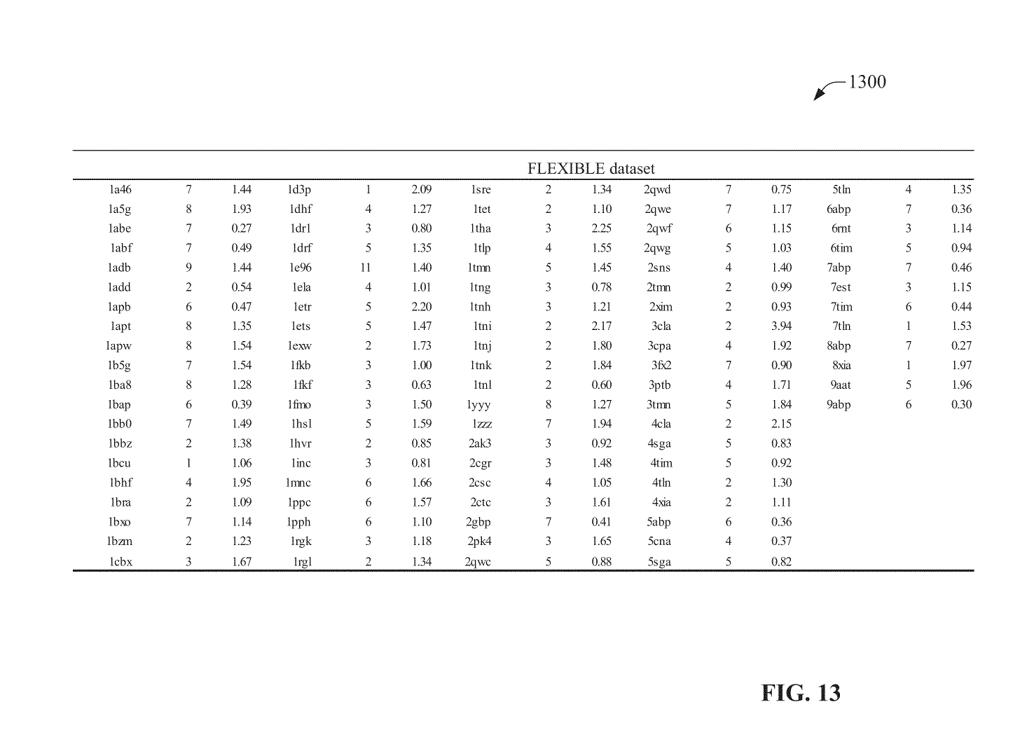

All of these complexes were downloaded from http://sw16.im.med.umich.edu/software/xtool/. The PDB names of 92 testing cases, each of which had at least one hydrogen bond, the number of intermolecular hydrogen bonds and the RMSD value (Angstroms) in the experimentally determined docked complexes are shown in FIG. 13.

### Docking Accuracy

To evaluate the performance of the fast protein-ligand docking systems and methods employing hydrogen bond matching and probabilistic relaxation labeling, for each complex of the dataset, the protein and ligand were separated from each other and the ligand was translated and rotated arbitrarily.

On the experiments, the root-mean square deviation (RMSD) between the experimentally observed heavy atom positions of ligands and the heavy atom positions of ligands predicted by the fast protein-ligand docking algorithm were used to measure the accuracy of the fast protein-ligand docking algorithm utilized by the systems and methods described herein.

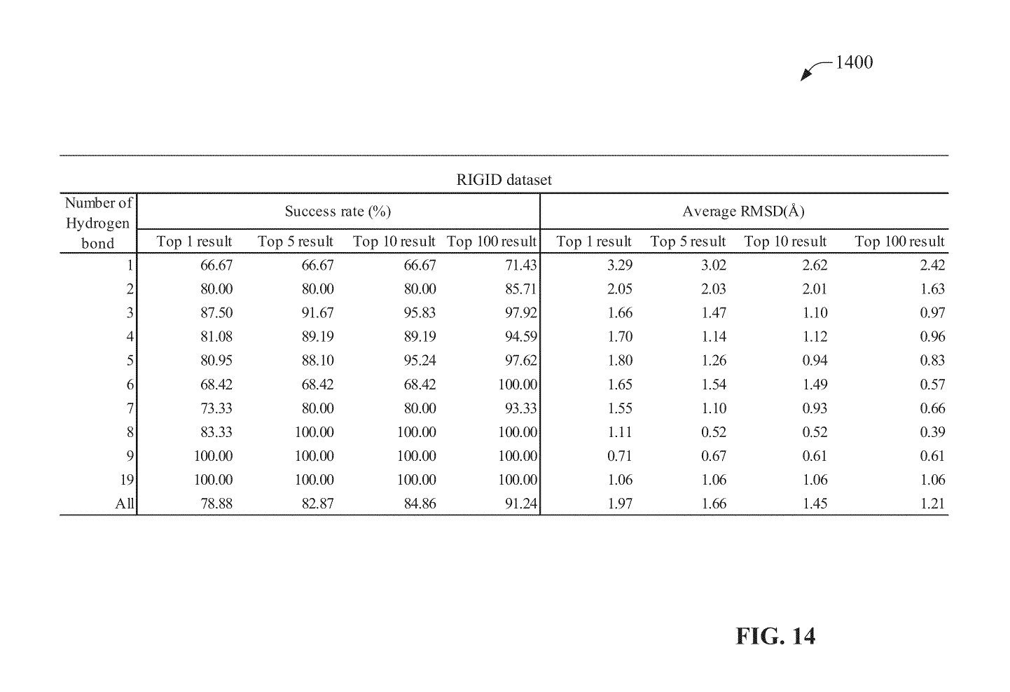

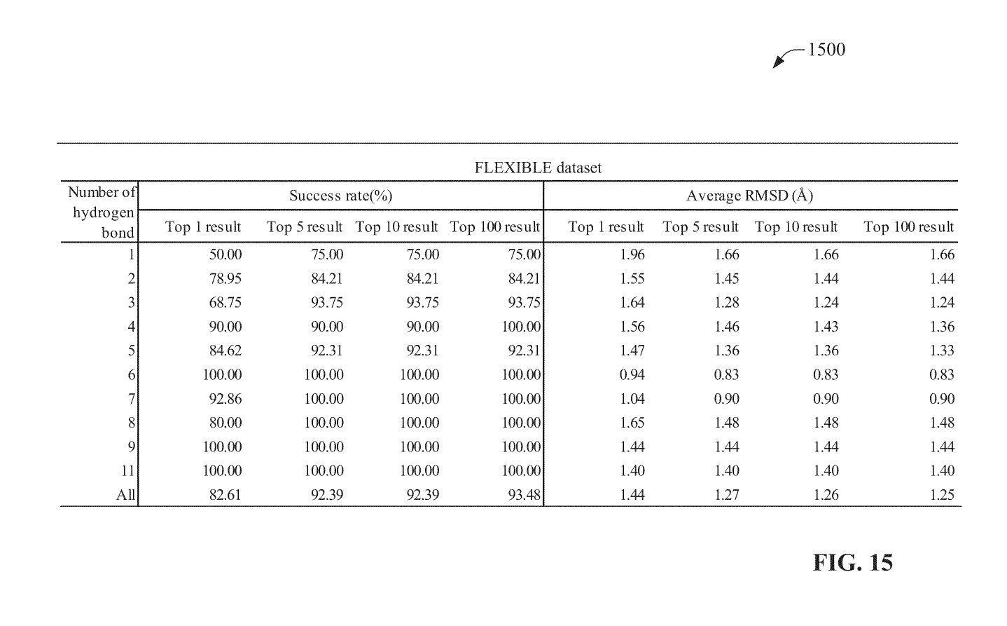

The detailed RMSD results for the rigid data set are shown in FIG. 14. The detailed RMSD results for the flexible data set are shown in FIG. 15. If at least one of the top t ranked results fell into the range of RMSD<2.0 Å, it was deemed a successful case for the top t ranked results.

The successful docking rates and the average RMSD of the fast protein-ligand docking algorithm with different numbers of intermolecular hydrogen bonds for rigid and flexible data sets are shown in FIGS. 14 and 15, respectively. The successful docking rate of the fast protein-ligand docking algorithm on the 251 rigid complexes was 78.88% with an average RMSD of 1.97 Å for the top 1 result. For flexible docking on the testing site, with 92 cases, the success rate was 82.61% with an average RMSD of 1.44 Å for the top 1 result.

Other conformations beside the top 1 result were also examined. The success rates and average RMSD of the fast protein-ligand docking algorithm calculated by considering the top 5 results, the top 10 results or the top 100 results are also shown in FIGS. 14 and 15. It is not surprising that the performance of the fast protein-ligand docking algorithm increased by considering more top-ranked results. When the true conformation was missed as the top 1, it often appeared among the next highly ranked configuration. For the top 100 results, the fast protein-ligand algorithm achieved a 91.24% success rate with an average RMSD of 1.21 Å for rigid docking and a 93.48% success rate with an average RMSD of 1.25 Å for flexible docking.

### Analysis of the Binding Mode Prediction

The fast protein-ligand docking algorithm performed better when the hydrogen bond number between protein and ligand increases. This may be due to the rules of the relaxation labeling process. However, the fast protein-ligand docking algorithm still obtains a relatively good performance when the number of intermolecular hydrogen bonds is small. The local shape complementarity task ensures a higher level of correctness of the initial probability estimation for matching. Thus, sometimes the right mode can be predicted with the initial probability directly. As a result, the docking accuracy for smaller number of hydrogen bonds can be improved accordingly. However, since the hydrogen bonding is not the only interaction between protein and ligand, other interactions such as solvent effect, electrostatic potentials make contribute more to the conformation of the ligand when the number of intermolecular hydrogen bonds is smaller. Thus the docking errors still occur, especially when the number of intermolecular hydrogen bonds is small. Another reason for the erroneous result we need to take into consideration is the method we use to identify the ligand position. For the one/two pair mode, the ligand still has freedom to rotate while keeping all geometric constraints imposed by hydrogen bonding satisfied. Therefore, even if the hydrogen bonding modes are correctly predicted, sometimes the native ligand position cannot be reproduced. The results can be improved if a small rotation increment is used in the displacement of the ligand. However, for the complex which has more than three hydrogen bonds, we only need to predict three correct hydrogen bonds so that the native ligand position can be identified.

### Computation Time

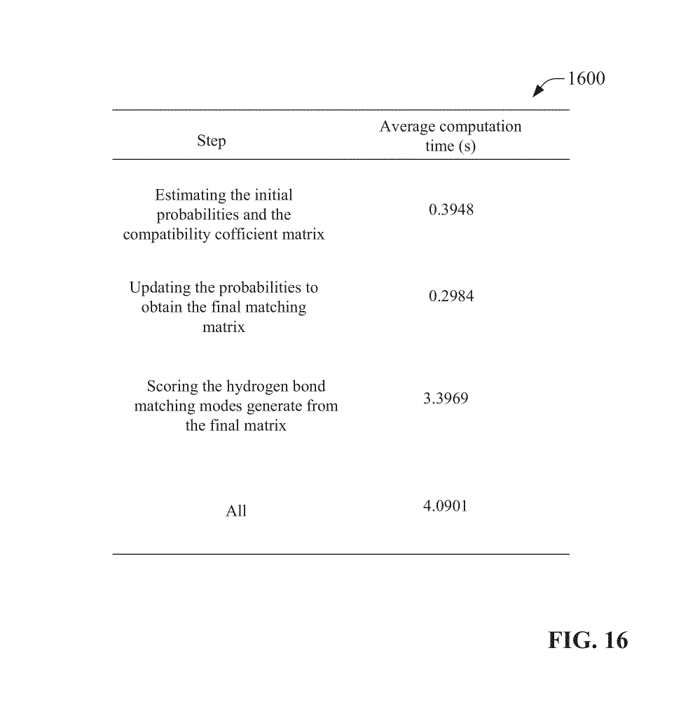

It is important to reduce the computation time for a docking algorithm. The fast protein-ligand docking algorithm was coded in MATLAB, all program runs were done on a dual core with CPU 2.8 GHz and 8G RAM. The fast protein-ligand docking algorithm was determined to take about 4.09 CPU seconds on average for a test. In FIG. 16, the average computation time for various steps of the proposed algorithm are represented. The step of computing the initial probability and compatibility coefficients is fast since with the local patch histogram, the rotations in 3D spaces are no longer needed to be considered. The step of updating the probabilities does not take much time either, given that convergence rate of relaxation labeling is quick. The most time-consuming part is the scoring step, because of the different combinations of matching modes. However, compared with H-DOCK, the number of matching modes decreases from tens of thousands to hundreds.

### Comparison to Other Docking Methods

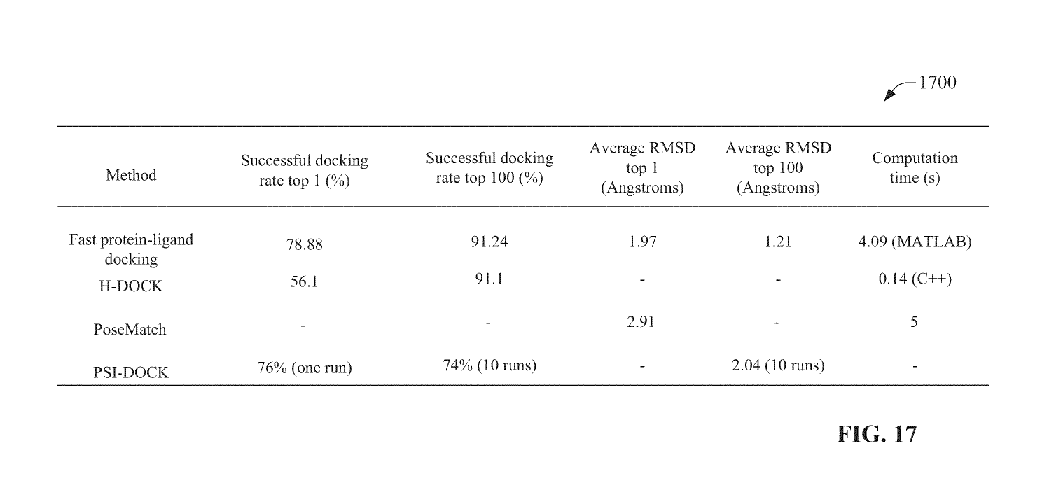

The results of the fast protein-ligand binding algorithm on the CCDC/Astex set were compared to those of the following shape complementarity-based methods: H-DOCK, PoseMatch and PSI-DOCK. H-DOCK is based on combinatorial hydrogen bond matching and surface shape complementarity. PoseMatch introduces a fast approximation scheme for the docking of rigid fragments that guarantees certain geometric approximation factors, in which a geometric shape descriptor structure is developed to model the molecular surface. PSI-DOCK develops a tabu-enhanced genetic protein-ligand docking algorithm with a rapid shape complementary scoring function. The subsets tested in these methods were not the same. The detailed datasets and the results published in Luo et al. A fast protein-ligand docking algorithm based on hydrogen bond matching and surface shape complementarity. J Mol Model 2010; 16: 903-913 (H-DOCK), Sadjad-Peleg A et al. Toward a robust search method for the protein-drug docking problem. IEEE/ACM Trans Comput Biol Bioinform 2011; 8: 1120-1133 (PoseMatch) and Pein J, et al. PSI-DOCK: towards highly efficient and accurate flexible ligand docking. Protein: Struct Funct Bioinform 2006; 62: 934-946 (PSI-DOCK) are presented in FIG. 17.

Although the algorithms were implemented in different programming languages and tested on different platforms, the comparison of experimental results clearly shows that the fast protein-ligand docking algorithm exhibited a higher docking accuracy than H-DOCK, PoseMatch and PSI-DOCK and that it was efficient in identifying the binding pose.

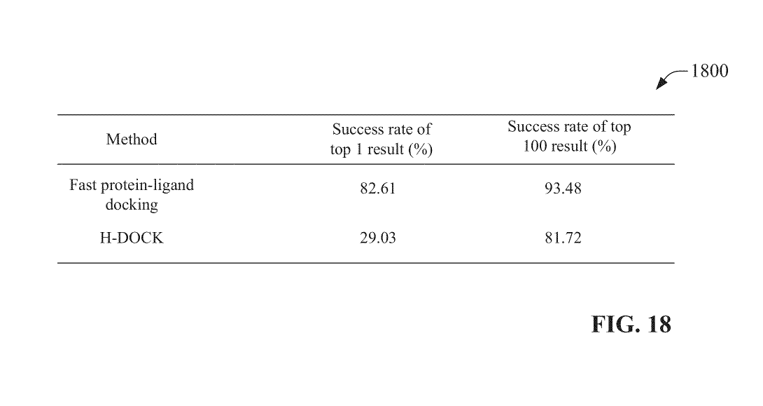

For the 92 flexible complexes, each of which has at least one intermolecular hydrogen bond, the results of the fast protein-ligand docking algorithm were compared to H-DOCK, as shown in FIG. 18. The fast protein-ligand docking algorithm had a higher average docking accuracy than H-DOCK. When the number of intermolecular hydrogen bonds was fewer than three, the corresponding success rate of H-DOCK, as published in Luo et al. A fast protein-ligand docking algorithm based on hydrogen bond matching and surface shape complementarity. J Mol Model 2010; 16: 903-913, was smaller than 10%. Compared to H-DOCK, the fast protein-ligand docking algorithm significantly enhanced the docking accuracy when the number of intermolecular hydrogen bonds is small, as shown in FIG. 18.

The above description of illustrated aspects and embodiments, including what is described in the Abstract, is not intended to be exhaustive or to limit the disclosed aspects and embodiments to the precise forms disclosed. While specific aspects and embodiments and examples are described herein for illustrative purposes, various modifications are possible that are considered within the scope of such aspects and embodiments and examples, as those skilled in the relevant art can recognize.

As used herein, the word “example” is used herein to mean serving as an example, instance, or illustration. For the avoidance of doubt, the subject matter described herein is not limited by such examples. In addition, any aspect or design described herein as an “example” is not necessarily to be construed as preferred or advantageous over other aspects or designs, nor is it meant to preclude equivalent structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

With respect to any numerical range for a given characteristic, a parameter from one range may be combined with a parameter from a different range from the same characteristic to generate a numerical range. Other than where otherwise indicated, all numbers, values, and/or expressions referring to quantities of ingredients, reaction conditions, etc., used in the specification and claims are to be understood as modified in all instances by the term “about.”

In this regard, while the described subject matter has been described in connection with various aspects and embodiments and corresponding Figures, where applicable, it is to be understood that other similar aspects and embodiments can be used or modifications and additions can be made to the described aspects and embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims.

What is claimed is:

1. A system, comprising:
a memory to store computer-executable instructions; and
a processor that executes or facilitates execution of the computer-executable instructions to at least:
obtain a potential binding site for a ligand on a surface of a macromolecule;
identify donor atoms and acceptor atoms on the potential binding site and the ligand;
solve a defined function through probabilistic relaxation labeling to facilitate identification of a set of potential matching pairs of the donors and the acceptors on the potential binding site and the ligand based on a geometric constraint for conformation of a physico-chemical interaction between the ligand and the potential binding site; and
rank potential matching pairs of the set of the potential matching pairs according to a defined scoring function to obtain a ligand position that satisfies a defined energy condition with respect to the potential binding site.

2. The system of claim 1, wherein the probabilistic relaxation labeling associates a set of labels on the ligand to a set of objects on the protein potential binding site based on the local patch histogram complementarities of hydrogen bond donors/acceptors.

3. The system of claim 1, wherein the donor atoms are hydrogen bond donor atoms, the acceptor atoms are hydrogen bond acceptor atoms, and the physico-chemical interaction between the ligand and the potential binding site comprises at least one hydrogen bond being formed between the ligand and the potential binding site.

4. The system of claim 1, wherein the processor further executes or facilitates the execution of the computer-executable instructions to:
determine ideal acceptors on the potential binding site and the ligand, wherein the ideal acceptors correspond to the hydrogen bond donors on the potential binding site and the ligand;
create a set of objects on the potential binding site of protein, wherein objects of the set of objects correspond to the acceptors and the donors on the potential binding site;
create a set of labels on the ligand, wherein labels of the set of labels correspond to the acceptors and the donors on the ligand;
estimate a matching probability matrix for the set of objects and the set of labels according to the probabilistic relaxation labeling based on the local patch histogram complementarities of hydrogen bond donors/acceptors; and
determine a set of potential hydrogen bonding modes from the matching probability matrix, wherein the set of potential hydrogen bonding modes corresponds to the set of potential matching pairs.

5. The system of claim 4, wherein the processor further executes or facilitates the execution of the computer-executable instructions to displace the ligand for each mode of the set of the potential hydrogen bonding modes according to a quaternion based best-fit RMSD algorithm,
wherein the quaternion based best-fit RMSD algorithm determines an optimal rigid transformation represented by a rotation matrix and a translation matrix to minimize a root mean squared error between a first set of points after a transformation by the rotation matrix and the translation matrix and a second set of points that is that is not transformed by the rotation matrix and the transformation matrix.

6. The system of claim 1, wherein the scoring function comprises a sum of van der Waals potentials between the potential binding site and the ligand.

7. The system of claim 1, wherein the scoring function accounts for an energy contribution of hydrogen bonds with regard to the physico-chemical interaction between the ligand and the potential binding site.

8. The system of claim 1, wherein the ligand has a rigid conformation or a flexible conformation when bound to the macromolecule.

9. A method, comprising:
creating, by a system comprising a processor, matched pairs of donors and acceptors between a ligand and a macromolecule surface via probability relaxation labeling based on local patch histogram complementarities of hydrogen bond donors/acceptors;
estimating, by the system, respective initial probabilities for the matched pairs;
determining, by the system, ligand positions associated with sets of at least two matched pairs of the matched pairs based on a rotation parameter and a translation parameter; and
ranking, by the system, the ligand positions according to a defined scoring function.

10. The method of claim 9, wherein the ranking further comprises:
displacing a ligand to different ligand positions based on the rotation parameter and the translation parameter; and
sorting the different ligand positions according to the scoring function.

11. The method of claim 9, further comprising selecting, by the system, a ligand position of the ligand positions according to the ranking.

12. The method of claim 11, wherein the ligand position is within a set of 100 lowest ranked ligand positions according to the ranking.

13. The method of claim 11, wherein the ligand position is within a set of 10 lowest ranked ligand positions according to the ranking.

14. The method of claim 9, further comprising identifying, by the system, a potential binding site on the macromolecule surface.

15. The method of claim 14, wherein the macromolecule is a protein and the potential binding site is a pocket on the surface of the protein.

16. A computer readable storage device comprising computer-executable instructions that, in response to execution, cause a system comprising a processor to perform operations, comprising:
identifying a potential binding site for a ligand on a surface of a macromolecule;
matching potential donor and acceptor pairs through relaxation labeling;
displacing the ligand using the quaternion based best-fit RMSD algorithm; and
determining a docked complex between the macromolecule and the ligand based on the displacing of the ligand that minimizes the scoring function.

17. The computer readable storage device of claim 16, wherein the determining further comprises finding the docked complex according to a defined scoring function expressed as a sum of van der Waals potentials between the macromolecule and the ligand and a functional condition that accounts for a contribution of a physico-chemical interaction between the ligand and the potential binding site.

18. The computer readable storage device of claim 16, wherein the matching potential donor and acceptor pairs through relaxation labeling.

19. The computer readable storage device of claim 16, wherein the operations further comprise:
determining respective initial probabilities with a local patch histogram of hydrogen bond donor and acceptor atoms; and
estimating respective compatibility matrices with respective coexistence conditions.

20. The computer readable storage device of claim 16, wherein the operations further comprise:
ranking potential docked complexes between the macromolecule and the ligand based on the scoring function; and
selecting a potential docked complex, of the potential docked complexes, ranked lowest as the docked complex between the macromolecule and the ligand.
